(19) United States
(12) Patent Application Publication
(10) Pub. No.: US 2023/0004777 A1
(43) Pub. Date: Jan. 5, 2023

(54) SPIKE NEURAL NETWORK APPARATUS BASED ON MULTI-ENCODING AND METHOD OF OPERATION THEREOF

(71) Applicant: Electronics and Telecommunications Research Institute, Daejeon (KR)

(72) Inventors: Sung Eun KIM, Daejeon (KR); Tae Wook KANG, Daejeon (KR); Hyuk KIM, Daejeon (KR); Young Hwan BAE, Daejeon (KR); Kyung Jin BYUN, Daejeon (KR); Kwang IL OH, Daejeon (KR); Jae-Jin LEE, Daejeon (KR); In San JEON, Daejeon (KR)

(73) Assignee: Electronics and Telecommunications Research Institute, Daejeon (KR)

(21) Appl. No.: 17/857,602

(22) Filed: Jul. 5, 2022

(30) Foreign Application Priority Data
Jul. 5, 2021 (KR) 10-2021-0088122
Jan. 6, 2022 (KR) 10-2022-0002101

(51) Int. Cl. G06N 3/04; G06N 3/063

(52) U.S. Cl. CPC G06N 3/04; G06N 3/063

(57) ABSTRACT

Disclosed are a spike neural network apparatus based on a multi-encoding and an operating method thereof. The method of operating a spike neural network (SNN) apparatus that performs a multi-encoding, includes receiving an input signal by an encoding module, performing a rate coding and a temporal coding on the received input signal by the encoding module, generating an SNN input signal based on the performance result of the rate coding and the temporal coding, and transmitting the generated SNN input signal to a neuromorphic chip that performs a spike neural network (SNN) operation.

### CROSS-REFERENCE TO RELATED APPLICATIONS

This application claims priority under 35 U.S.C. § 119 to Korean Patent Application Nos. 10-2021-0088122, filed on Jul. 5, 2021, and 10-2022-0002101, filed on Jan. 6, 2022, respectively, in the Korean Intellectual Property Office, the disclosures of which are incorporated by reference herein in their entireties.

### BACKGROUND

Embodiments of the present disclosure described herein relate to a spike neural network apparatus, and more particularly, relate to a spike neural network apparatus performing a plurality of encoding methods on an input signal, and an operating method thereof.

Interest in artificial intelligence technologies that process information by applying human thinking, inference, and learning processes to electronic devices is increasing, and technologies for processing information by mimicking neurons and synapses included in a human brain are also being developed. There are various types of neurons and synapses constituting the human brain, and research on signal processing between neurons or between synapses is still ongoing. Most of the currently developed SNN-based neuromorphic systems are based on leaky-integrate-and-fire (LIF) neuron models, but the neuromorphic system based on the LIF neuron model does not fully utilize characteristics of various neuronal models studied in the human brain.

### SUMMARY

Embodiments of the present disclosure provide a spike neural network apparatus and an operating method thereof, which pre-process an input signal through mixing a plurality of encoding methods, and perform signal processing based thereon.

According to an embodiment of the present disclosure, a method of operating a spike neural network (SNN) apparatus that performs a multi-encoding, includes receiving an input signal by an encoding module, performing a rate coding and a temporal coding on the received input signal by the encoding module, generating an SNN input signal based on the performance result of the rate coding and the temporal coding, and transmitting the generated SNN input signal to a neuromorphic chip that performs a spike neural network (SNN) operation.

According to an embodiment, the performing of the rate coding and the temporal coding on the received input signal by the encoding module may include performing the rate coding on the input signal, and performing the temporal coding on the performance result of the rate coding.

According to an embodiment, the method may further include performing at least one of a phase coding and a synchronous coding on the performance result of the rate coding and the temporal coding.

According to an embodiment, the temporal coding may be performed based on a frequency or a time margin of spike signals of the input signal.

According to an embodiment, the performing of the SNN operation may include generating an SNN output signal representing a classification result of the SNN input signal.

According to an embodiment, the SNN output signal may be one of at least four signals classified according to an identity.

According to an embodiment, the SNN output signal may be one of the at least four signals classified according to the identity from two output neurons.

According to an embodiment, the SNN output signal may represent the classification result based on the rate coding and the temporal coding.

According to an embodiment of the present disclosure, a spike neural network (SNN) apparatus that performs a multi-encoding, includes a neuromorphic chip that receives an input signal and generates an SNN input signal and an SNN output signal, and a memory that stores the SNN input signal and the SNN output signal, and the neuromorphic chip performs a rate coding and a temporal coding on the received input signal, generates the SNN input signal based on the performance result, and generates the SNN output signal from the generated SNN input signal by performing a spike neural network (SNN) operation.

According to an embodiment, the SNN output signal may represent a classification result of the SNN input signal based on the rate coding and the temporal coding.

According to an embodiment, the SNN output signal may be one of at least four signals classified according to an identity.

According to an embodiment, the SNN output signal may be one of the at least four signals classified according to the identity from two output neurons.

According to an embodiment, the neuromorphic chip may be implemented with a network-on-chip (NoC) including first to N-th clusters (where ‘N’ is a natural number equal to or greater than 4).

According to an embodiment, the NoC may be implemented with one of a mesh structure and a tree structure.

According to an embodiment, the first cluster may perform the rate coding on the input signal, and the second cluster may perform the temporal coding on an output of the first cluster.

According to an embodiment, the third cluster may perform a phase coding on an output of the second cluster, and the fourth cluster may perform a synchronous coding on the output of the second cluster or an output of the third cluster.

According to an embodiment, with respect to the input signal, the first cluster may perform the rate coding, the second cluster may perform the temporal coding, the third cluster may perform a phase coding, and the fourth cluster may perform a synchronous coding, and the neuromorphic chip may generate the SNN input signal by interfacing the performance results of each of the first to fourth clusters.

### BRIEF DESCRIPTION OF THE FIGURES

The above and other objects and features of the present disclosure will become apparent by describing in detail embodiments thereof with reference to the accompanying drawings.

FIG. 1 is a block diagram of a spike neural network apparatus, according to an embodiment of the present disclosure.

FIG. 2 is a diagram illustrating an encoding module, according to an embodiment of the present disclosure.

FIG. 3 is a diagram illustrating an example of an encoding module, according to an embodiment of the present disclosure.

FIGS. 4A and 4B are diagrams illustrating performance results of each operation of the spike neural network apparatus, according to an embodiment of the present disclosure.

FIG. 5 is a flowchart illustrating an operation of a spike neural network apparatus, according to an embodiment of the present disclosure.

FIG. 6 is a block diagram of a spike neural network apparatus, according to an embodiment of the present disclosure.

FIGS. 7A and 7B are diagrams illustrating configurations for implementing a neuromorphic chip function, according to an embodiment of the present disclosure.

FIG. 8 is a flowchart illustrating an operation of a spike neural network apparatus, according to an embodiment of the present disclosure.

FIG. 9 is a flowchart illustrating an operation of a spike neural network apparatus, according to an embodiment of the present disclosure.

### DETAILED DESCRIPTION

Hereinafter, with reference to the accompanying drawings, embodiments of the present disclosure will be described clearly and in detail such that those skilled in the art may easily carry out the present disclosure. In addition, a signal in the present specification may include a plurality of signals in some cases. A signal in the present specification may include a plurality of signals in some cases, and the plurality of signals may be different signals.

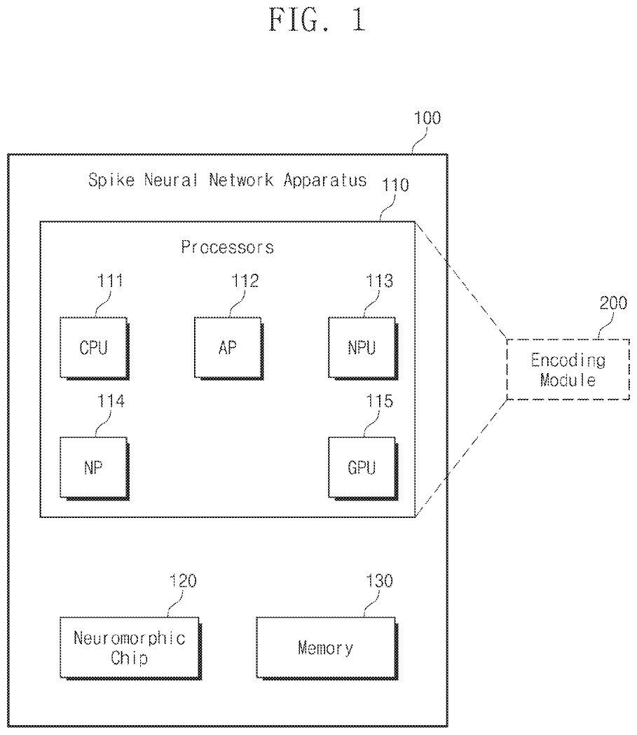

FIG. 1 illustrates a block diagram of a spike neural network apparatus 100, according to an embodiment of the present disclosure. Referring to FIG. 1, the spike neural network apparatus 100 may include an encoding module 200, processors 110, a neuromorphic chip 120, and a memory 130.

The processors 110 may function as a central processing unit of the spike neural network apparatus 100. At least one of the processors 110 may drive the encoding module 200. The processors 110 may include at least one general purpose processor, such as a central processing unit 111 (CPU), an application processor 112 (AP), etc. The processors 110 may also include at least one special purpose processor, such as a neural processing unit 113, a neuromorphic processor 114, a graphics processing unit 115 (GPU), etc. The processors 110 may include two or more homogeneous processors. As another example, at least one (or at least the other) of the processors 110 may be manufactured to implement various machine learning or deep learning modules.

At least one of the processors 110 may execute the encoding module 200. The encoding module 200 may perform at least two encoding methods with respect to an input signal received to the encoding module 200. At least one of the processors 110 may execute the encoding module 200 to perform an encoding method suitable for extracting a characteristic desired by a user. For example, the encoding module 200 may perform a rate coding and a temporal coding with respect to the input signal received to the encoding module 200. In this case, the encoding module 200 may perform the rate coding and the temporal coding simultaneously or sequentially.

For example, when the encoding module 200 performs the rate coding on an input signal, a signal including first characteristic information (e.g., strength of an input signal) may be generated as a performance result of the rate coding. When the encoding module 200 performs the temporal coding on the input signal, a signal including second characteristic information (e.g., frequency or time information of the input signal) may be generated as a performance result of the temporal coding.

For example, when the encoding module 200 performs the rate coding on an input signal and performs the temporal coding on the performance result of the rate coding, the encoding module 200 may generate a signal including the first characteristic information (e.g., the strength of the input signal) and the second characteristic information (e.g., a frequency or time margin between spike signals generated as a performance result of the rate coding).

For example, when at least one of the processors 110 executes the encoding module 200 to perform the rate coding, the encoding module 200 may generate a number of spike signals proportional to the strength of the input signal as a performance result of the rate coding. When at least one of the processors 110 executes the encoding module 200 to perform the temporal coding, the encoding module 200 may represent the strength or identity of the input signal based on the time margin of the spike signals of the input signal or the frequency of the spike signals of the input signal.

As another example, at least one of the processors 110 may execute the encoding module 200 to perform the phase coding or the synchronous coding on the input signal received to the encoding module 200. For example, when at least one of the processors 110 executes the encoding module 200 to perform the phase coding, the performance result may include a change characteristic depending on a time of the input signal. In addition, when at least one of the processors 110 executes the encoding module 200 to perform the synchronous coding, the encoding module 200 may generate an output signal in an emergency situation (e.g., when a plurality of input spike signals are simultaneously fired).

At least one of the processors 110 may execute the encoding module 200 to generate an SNN input signal based on a performance result of encoding the input signal. At least one of the processors 110 may transmit the generated SNN input signal to the neuromorphic chip 120.

At least one of the processors 110 may request the neuromorphic chip 120 to perform an SNN operation on signals or data. For example, at least one of the processors 110 may transmit the SNN input signal generated from the encoding performance result to the neuromorphic chip 120, and may request the neuromorphic chip 120 that receives the SNN input signal to perform the SNN operation. In this case, the neuromorphic chip 120 may generate an SNN output signal representing a classification result of the SNN input signal as a result of the SNN operation.

The encoding module 200 may be implemented in the form of instructions (or codes) executed by at least one of the processors 110. In this case, at least one of the processors 110 may store the instructions (or codes) of the encoding module 200 in the memory 130.

At least one (or at least another) of the processors 110 may be manufactured to implement the encoding module 200. For example, the at least one processor may be a dedicated processor implemented in hardware based on the encoding module 200 generated by learning of the encoding module 200.

The neuromorphic chip 120 may perform an SNN operation. For example, the neuromorphic chip 120 may perform the SNN operation on the SNN input signal received from the encoding module 200 and may generate an SNN output signal representing a classification result of the SNN input signal.

The neuromorphic chip 120 may be implemented with a network-on-chip (NoC) including first to N-th clusters (where ‘N’ is a natural number equal to or greater than 4). In this case, the NoC may be implemented in the form of a mesh type, a tree (e.g., a quad-tree or a binary tree) type, or a torus (e.g., a folded-torus) type.

The memory 130 may store data and process codes being processed or to be processed by the processors 110. For example, in some embodiments, the memory 130 may store data to be input to the spike neural network apparatus 100 or data generated or trained in a process of performing encoding by the processors 110. For example, the memory 130 may store the SNN input signal generated from the encoding module 200 and the SNN output signal generated from the neuromorphic chip 120.

The memory 130 may be used as a main memory device of the spike neural network apparatus 100. The memory 130 may include a dynamic random access memory (DRAM), a static RAM (SRAM), a phase-change RAM (PRAM), a magnetic RAM (MRAM), a ferroelectric RAM (FeRAM), a resistive RAM (RRAM), etc.

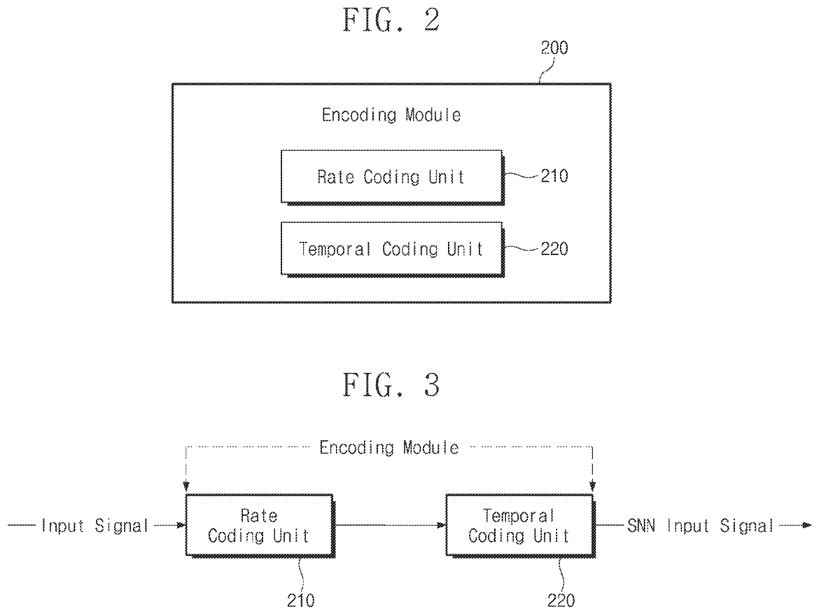

FIG. 2 illustrates the encoding module 200, according to an embodiment of the present disclosure. Referring to FIG. 2, the encoding module 200 may include a rate coding unit 210 and a temporal coding unit 220. The rate coding unit 210 may perform a rate coding on an input signal. The temporal coding unit 220 may perform a temporal coding on the input signal or a performance result of the rate coding.

Unlike that illustrated in FIG. 2, the encoding module 200 may include a phase coding unit performing a phase coding or a synchronous coding unit performing a synchronous coding. In addition, the encoding module 200 may further include a separate coding units for performing various encodings.

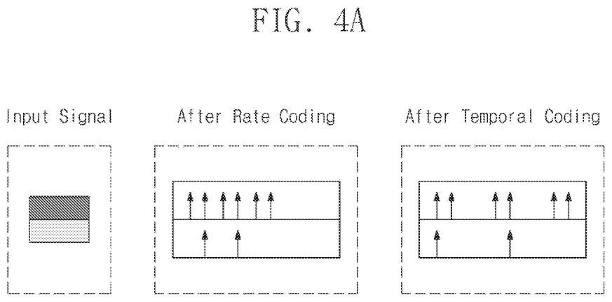

FIG. 3 is a diagram illustrating an example of the encoding module 200, according to an embodiment of the present disclosure. Referring to FIGS. 2 and 3, the encoding module 200 may receive an input signal, and the rate coding unit 210 may perform the rate coding on the received input signal. The temporal coding unit 220 may perform a temporal coding on a performance result of the rate coding. The encoding module 200 may generate an SNN input signal from a performance result of the temporal coding.

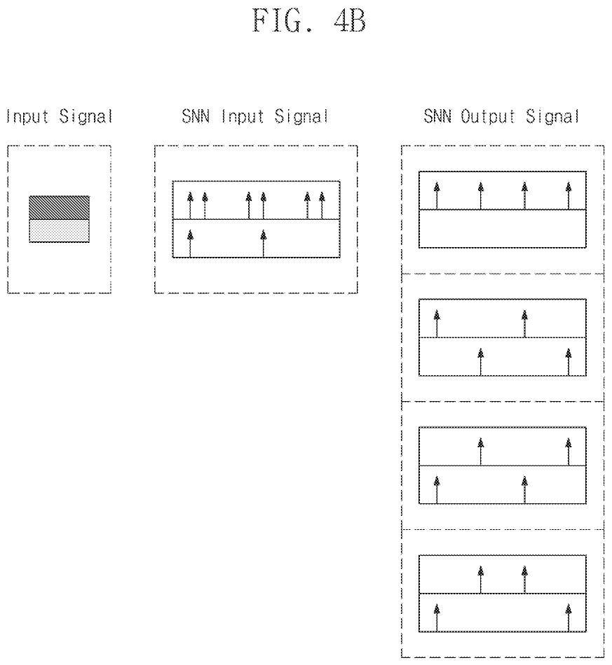

FIGS. 4A and 4B illustrate performance results of each operation of the spike neural network apparatus, according to an embodiment of the present disclosure. Referring to FIG. 4A, the encoding module 200 may receive an input signal including a first region having a relatively high strength and a second region having a relatively weak strength. When the rate coding is performed on an input signal including the first region and the second region, the rate coding performance result corresponding to the first region may include more spike signals than the rate coding performance result corresponding to the second region. When the temporal coding is performed on the result of performing the rate coding, the result of performing the temporal coding may include information (e.g., a frequency of the spike signals of the input signal including the first region and the second region or a time margin of the spike signals of the input signal including the first region and the second region) associated with a time of spike signals generated by performing the rate coding.

Referring to FIGS. 4A and 4B, the encoding module 200 may generate the SNN input signal based on a result of performing encoding. In this case, the SNN input signal may include signals corresponding to the first region and the second region. The neuromorphic chip 120 may perform an SNN operation on the generated SNN input signal and may generate an SNN output signal representing a classification result of the SNN input signal. In this case, the SNN output signal may be one of at least four signals classified according to an identity. In addition, the SNN output signal may be one of at least four signals classified according to the identity from two output neurons.

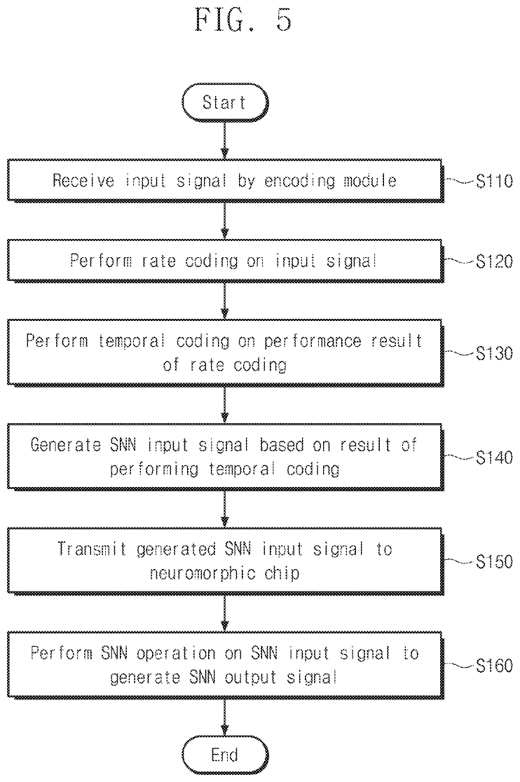

FIG. 5 illustrates a flowchart of an operation of the spike neural network apparatus 100, according to an embodiment of the present disclosure. Referring to FIG. 5, the spike neural network apparatus 100 may perform operations S110 to S160.

In operation S110, the encoding module 200 may receive an input signal.

In operation S120, the encoding module 200 may perform the rate coding on the received input signal under the control of at least one of the processors 110. In this case, the rate coding unit 210 of the encoding module 200 may perform the rate coding.

In operation S130, the encoding module 200 may perform the temporal coding on the performance result of the rate coding under the control of at least one of the processors 110. In this case, the temporal coding unit 220 of the encoding module 200 may perform the temporal coding.

In operation S140, the encoding module 200 may generate the SNN input signal based on a result of performing the temporal coding under the control of at least one of the processors 110.

In operation S150, the encoding module 200 may transmit the generated SNN input signal to the neuromorphic chip 120 under the control of at least one of the processors 110.

In operation S160, the neuromorphic chip 120 may perform the SNN operation on the SNN input signal received from the encoding module 200 and may generate the SNN output signal representing a classification result of the SNN input signal. The neuromorphic chip 120 may classify the identity based on the relative strength of the SNN input signal, and the SNN output signal may be one of at least four signals classified according to the identity. In this case, the SNN input signal is respectively input to at least two input neurons of an input layer of the spike neural network, and at least four signals classified according to their identities may be output from at least two output neurons of an output layer of the spike neural network.

The signals or data generated in operations S110 to S160 (e.g., the rate coding performance result, the temporal coding performance result, the SNN input signal, and the SNN output signal) may be stored in the memory 130.

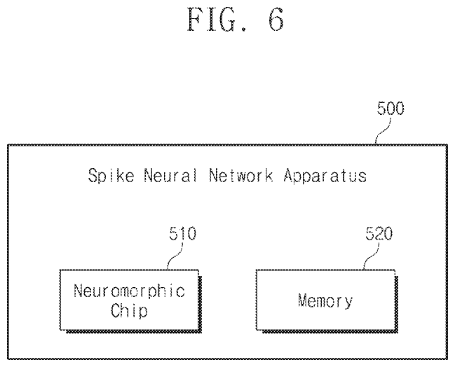

FIG. 6 illustrates a block diagram of a spike neural network apparatus 500, according to an embodiment of the present disclosure. Referring to FIG. 6, the spike neural network apparatus 500 may include a neuromorphic chip 510 and a memory 520.

The neuromorphic chip 510 may receive an input signal from the outside, and may perform at least two encoding methods on the received input signal. The neuromorphic chip 510 may simultaneously or sequentially perform at least two encoding methods. The neuromorphic chip 510 may perform an encoding method suitable for extracting a characteristic desired by a user.

For example, the neuromorphic chip 510 may receive an input signal, and may perform the rate coding and the temporal coding on the received input signal. The neuromorphic chip 510 may generate an SNN input signal based on a result of performing encoding, and may perform an SNN operation to generate an SNN output signal from the SNN input signal. In this case, the SNN output signal may represent a classification result of the SNN input signal based on the encoding performance result.

The neuromorphic chip 510 may correspond to the neuromorphic chip 120 described with reference to FIG. 1. Therefore, the neuromorphic chip 510 is implemented with a network-on-chip (NoC), and the NoC may be implemented in the form of a mesh type, a tree (e.g., a quad tree or a binary tree) type, or a torus (e.g., a folded-torus) type.

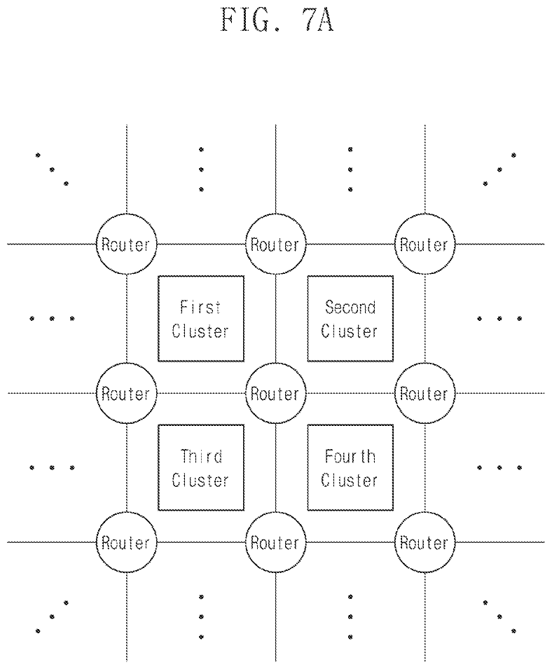

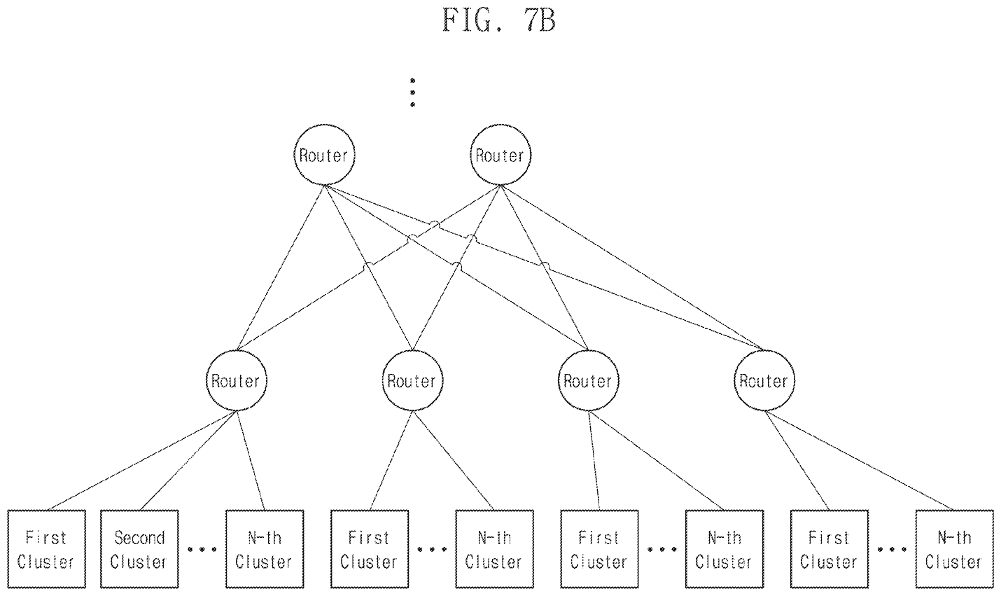

FIGS. 7A and 7B illustrate configurations for implementing the function of the neuromorphic chip 510, according to an embodiment of the present disclosure. Referring to FIGS. 7A and 7B, the neuromorphic chip 510 may be implemented with a mesh-type NoC or a tree-type NoC. In FIGS. 7A and 7B, the components are illustrated in a planar shape for convenience, but according to an embodiment of the present disclosure, the components illustrated in FIGS. 7A and 7B may be arranged in a three-dimensional shape.

The neuromorphic chip 510 may include a plurality of clusters and a plurality of routers corresponding to the plurality of clusters. For example, the neuromorphic chip 510 may include first to N-th clusters (where ‘N’ is a natural number equal to or greater than 4), and may include at least one router corresponding to each cluster. The plurality of routers may be reconfigurable routers that perform signal connections between the plurality of clusters. Although not illustrated, the neuromorphic chip 510 may include a plurality of interconnects for transferring information between a plurality of routers.

Each of the plurality of clusters may receive input information through at least one router, and may perform an operation on the received input information to transmit the operation result through the router. For example, each of the plurality of clusters may provide an operation result, and may output path information representing the cluster to receive the operation result through a router. In this case, at least one interconnect between routers may provide the operation result to at least one other cluster.

Each of the plurality of clusters may perform different encoding methods on the signal received to the neuromorphic chip 510. In this case, each of the plurality of clusters may simultaneously or sequentially perform different encoding methods. For example, with respect to the SNN input signal received by the neuromorphic chip 510, a first cluster may perform the rate coding, a second cluster may perform the temporal coding, a third cluster may perform the phase coding, and a fourth cluster may perform the synchronous coding.

As another example, with respect to the SNN input signal received by the neuromorphic chip 510, a first cluster may perform the rate coding, a second cluster may perform the temporal coding on an output of the first cluster, a third The cluster may perform the phase coding on an output of the second cluster, and the fourth cluster may perform the synchronous coding on the output of the second cluster or an output of the third cluster.

The memory 520 may correspond to the memory 130 described with reference to FIG. 1. The memory 520 may store data to be input to the spike neural network apparatus 500, data generated during encoding of the neuromorphic chip 510, or data generated during an SNN operation of the neuromorphic chip 510. In addition, the memory 520 may be used as a main memory device of the spike neural network apparatus 500.

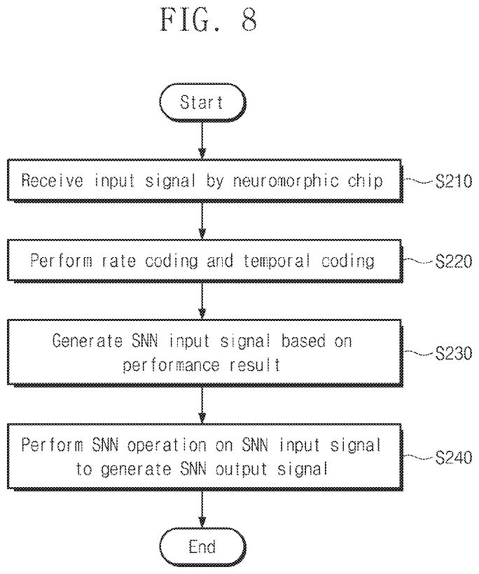

FIG. 8 illustrates a flowchart of an operation of the spike neural network apparatus 500, according to an embodiment of the present disclosure. Referring to FIG. 8, the spike neural network apparatus 500 may perform operations S210 to S240.

In operation S210, the neuromorphic chip 510 may receive an input signal.

In operation S220, the neuromorphic chip 510 may perform the rate coding and the temporal coding on the received input signal. The neuromorphic chip 510 may perform the rate coding and the temporal coding simultaneously or sequentially. For example, the first cluster may perform the rate coding, and the second cluster may perform the temporal coding on the output of the first cluster.

In operation S230, the neuromorphic chip 510 may generate the SNN input signal based on the results of performing the rate coding and the temporal coding.

In operation S240, the neuromorphic chip 510 may perform an SNN operation on the generated SNN input signal and may generate an SNN output signal representing a classification result of the SNN input signal. The neuromorphic chip 510 may classify the identity based on the relative strength of the SNN input signal, and the SNN output signal may be one of at least four signals classified according to the identity. In this case, the SNN input signal is respectively input to at least two input neurons of an input layer of the spike neural network, and at least four signals classified according to their identities may be output from at least two output neurons of an output layer of the spike neural network.

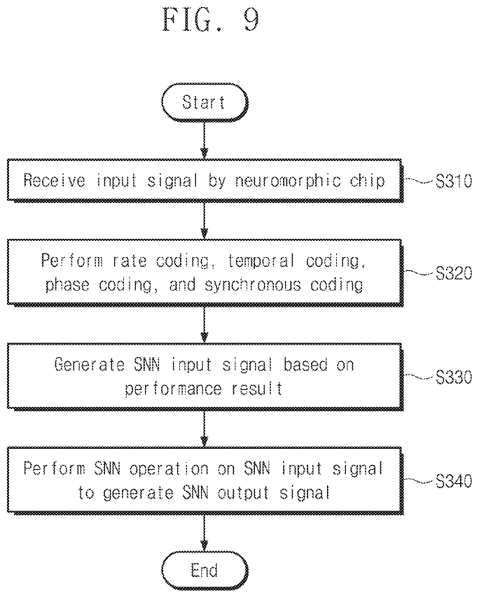

FIG. 9 illustrates a flowchart of an operation of the spike neural network apparatus 500, according to an embodiment of the present disclosure. Referring to FIG. 9, the spike neural network apparatus 500 may perform operations S310 to S340.

In operation S310, the neuromorphic chip 510 may receive an input signal.

In operation S320, the neuromorphic chip 510 may perform the rate coding, the temporal coding, the phase coding, and the synchronous coding on the received input signal. The neuromorphic chip 510 may perform the rate coding, the temporal coding, the phase coding, and the synchronous coding simultaneously or sequentially. For example, the first cluster may perform the rate coding, the second cluster may perform the temporal coding on an output of the first cluster, the third cluster may perform the phase coding on an output of the second cluster, and the fourth cluster may perform the synchronous coding on the output of the second cluster or an output of the third cluster. For example, one of the phase coding and the synchronous coding may be omitted.

For example, with respect to the SNN input signal received by the neuromorphic chip 510, the first cluster may perform the rate coding, the second cluster may perform the temporal coding, the third cluster may perform the phase coding, and the fourth cluster may perform the synchronous coding.

In operation S330, the neuromorphic chip 510 may generate the SNN input signal based on performance results of the rate coding, the temporal coding, the phase coding, and the synchronous coding.

As another example, when the first to fourth clusters each perform different encoding on the input signal received by the neuromorphic chip 510, the neuromorphic chip 510 may generate the SNN input signal by interfacing the performance results of each of the first to fourth clusters.

In operation S340, the neuromorphic chip 510 may perform an SNN operation on the generated SNN input signal and may generate an SNN output signal representing a classification result of the SNN input signal. The neuromorphic chip 510 may classify the identity based on the relative strength of the SNN input signal, and the SNN output signal may be one of at least four signals classified according to the identity. In this case, the SNN input signal is respectively input to at least two input neurons of an input layer of the spike neural network, and at least four signals classified according to their identities may be output from at least two output neurons of an output layer of the spike neural network.

According to an embodiment of the present disclosure, a spike neural network apparatus may contain more information in the input signal by remodeling the input signal by mixing various encoding methods. Accordingly, it is possible to improve the operation efficiency or the signal processing efficiency of the spike neural network apparatus, and to minimize the configuration of hardware required to process signals.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. Accordingly, the scope of the present disclosure should not be limited to the above-described embodiments and should be defined by equivalents of the claims as well as the claims to be described later.

What is claimed is:

1. A method of operating a spike neural network (SNN) apparatus that performs a multi-encoding, the method comprising:
receiving an input signal by an encoding module;
performing a rate coding and a temporal coding on the received input signal by the encoding module;
generating an SNN input signal based on the performance result of the rate coding and the temporal coding; and
transmitting the generated SNN input signal to a neuromorphic chip that performs a spike neural network (SNN) operation.

2. The method of claim 1, wherein the performing of the rate coding and the temporal coding on the received input signal by the encoding module includes:
performing the rate coding on the input signal; and
performing the temporal coding on the performance result of the rate coding.

3. The method of claim 1, further comprising:
performing at least one of a phase coding and a synchronous coding on the performance result of the rate coding and the temporal coding.

4. The method of claim 1, wherein the temporal coding is performed based on a frequency or a time margin of spike signals of the input signal.

5. The method of claim 1, wherein the performing of the SNN operation includes generating an SNN output signal representing a classification result of the SNN input signal.

6. The method of claim 5, wherein the SNN output signal is one of at least four signals classified according to an identity.

7. The method of claim 6, wherein the SNN output signal is one of the at least four signals classified according to the identity from two output neurons.

8. The method of claim 5, wherein the SNN output signal represents the classification result based on the rate coding and the temporal coding.

9. A spike neural network (SNN) apparatus that performs a multi-encoding comprising:
a neuromorphic chip configured to receive an input signal and to generate an SNN input signal and an SNN output signal; and
a memory configured to store the SNN input signal and the SNN output signal, and
wherein the neuromorphic chip:
performs a rate coding and a temporal coding on the received input signal;
generates the SNN input signal based on the performance result; and
generates the SNN output signal from the generated SNN input signal by performing a spike neural network operation.

10. The spike neural network apparatus of claim 9, wherein the SNN output signal represents a classification result of the SNN input signal based on the rate coding and the temporal coding.

11. The spike neural network apparatus of claim 10, wherein the SNN output signal is one of at least four signals classified according to an identity.

12. The spike neural network apparatus of claim 11, wherein the SNN output signal is one of the at least four signals classified according to the identity from two output neurons.

13. The spike neural network apparatus of claim 9, wherein the neuromorphic chip is implemented with a network-on-chip (NoC) including first to N-th clusters (where ‘N’ is a natural number equal to or greater than 4).

14. The spike neural network apparatus of claim 13, wherein the NoC is implemented with one of a mesh structure and a tree structure.

15. The spike neural network apparatus of claim 13, wherein the first cluster performs the rate coding on the input signal, and the second cluster performs the temporal coding on an output of the first cluster.

16. The spike neural network apparatus of claim 15, wherein the third cluster performs a phase coding on an output of the second cluster, and the fourth cluster performs a synchronous coding on the output of the second cluster or an output of the third cluster.

17. The spike neural network apparatus of claim 13, wherein, with respect to the input signal,
the first cluster performs the rate coding;
the second cluster performs the temporal coding;
the third cluster performs a phase coding; and
the fourth cluster performs a synchronous coding, and
wherein the neuromorphic chip generates the SNN input signal by interfacing the performance results of each of the first to fourth clusters.
